(19) United States
(12) Patent Application Publication
(10) Pub. No.: US 2024/0367989 A1
(43) Pub. Date: Nov. 7, 2024

(54) PREPARATION OF LITHIUM CARBONATE AND LITHIUM HYDROXIDE

(71) Applicant: International Battery Metals, Ltd, Houston, TX (US)

(72) Inventor: John L. BURBA, Houston, TX (US)

(73) Assignee: International Battery Metals, Ltd., Houston, TX (US)

(21) Appl. No.: 18/644,735

(22) Filed: Apr. 24, 2024

Related U.S. Application Data
(60) Provisional application No. 63/463,548, filed on May 2, 2023.

(51) Int. Cl. C01D 15/08; C01D 15/02

(52) U.S. Cl. CPC C01D 15/08; C01D 15/02; C01P 2006/80

(57) ABSTRACT

Aspects of this invention relate to preparing lithium carbonate and lithium hydroxide using an ion exchange resin. An example method can include adding an aqueous composition comprising lithium ions into a column. The column may include ion exchange resins saturated with sodium. The example method can include adding water into the column to remove residual sodium salts and adding a sodium hydroxide solution to the column to obtain lithium hydroxide.

### CROSS-REFERENCE TO RELATED APPLICATIONS

This application claims priority to U.S. Provisional Patent Application No. 63/463,548, entitled “SYSTEM AND METHOD FOR PRODUCING LITHIUM CARBONATE AND LITHIUM HYDROXIDE”, filed on May 2, 2023, the contents of which are incorporated herein by reference in their entirety.

### BACKGROUND

### 1. Technical Field

The present disclosure generally relates to preparing lithium carbonate and lithium hydroxide. For example, aspects of the present disclosure relate to preparing battery-grade lithium carbonate and lithium hydroxide using an ion exchange resin.

### 2. Introduction

Geothermal brines, which are hot water or steam containing dissolved minerals that are extracted from the Earth's subsurface during geothermal energy production, offer several benefits. For example, geothermal brines can be a source of renewable energy.

In some cases, geothermal brines can be a potential source of lithium, which may be used in batteries for electric vehicles, electronics, and energy storage systems. For example, some geothermal brines can contain dissolved lithium, which can be extracted through a series of extraction and purification steps.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for preparing lithium carbonate and lithium hydroxide, according to some examples of the present disclosure; and

FIG. 2 illustrates an example workflow for preparing lithium carbonate and lithium hydroxide, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As previously described, some geothermal brines contain dissolved lithium. As such, lithium carbonate (Li₂CO₃) can be prepared from lithium-containing brines or lithium minerals through a series of chemical processes. For example, lithium-containing brines or minerals that are mined can be processed at high temperatures to produce lithium oxide (Li₂O). The resulting lithium oxide can then be reacted with water to form lithium hydroxide (LiOH), which can be treated with sodium carbonate (soda ash) in solution such as a lithium chloride solution (LiCl). The reaction results in the precipitation of lithium carbonate. However, the sodium carbonate reagent is derived from Trona (Na₃H(CO₃)₂·H₂O), which is a naturally occurring mineral that contains impurities such as calcium, magnesium, sulfate, and so on. Due to such impurities, the crude lithium carbonate product needs to be filtered with substantial washing to remove soluble salts. As such, it is necessary for lithium carbonate to undergo multiple washings to improve the purity.

To produce purified lithium carbonate, the lithium carbonate from the above-described process can be slurried in water and pumped into a pressure vessel where CO₂ is injected. This induces a reaction in which the CO₂ reacts with the carbonate ions, forming lithium bicarbonate (LiHCO₃), which is very soluble. This solution can be passed through ion exchange columns underpressure. Impurities such as calcium and magnesium are exchanged for sodium and removed from the solution. When the CO₂ gas is vented from the vessel and as the CO₂ leaves the vessel, purified lithium carbonate precipitates. The lithium carbonate precipitates can be then filtered, washed, dried, sized, and/or packaged. However, this process involves numerous steps and can be expensive.

Further, in order to produce lithium hydroxide, lithium carbonate can be mixed in boiling water under pressure with slaked lime (e.g., calcium hydroxide). Calcium from the lime may react with carbonate from the lithium carbonate to produce impure lithium hydroxide and calcium carbonate waste. The impure slurry can be filtered and washed with water to capture residual lithium hydroxide. The lithium hydroxide solution is then evaporated and crystallized to remove the impurities. The process of evaporation, crystallization, and filtration can be repeated multiple times to acquire battery-grade lithium hydroxide. If the lithium carbonate and lime have poor quality, it may be necessary to recrystallize lithium hydroxide numerous times to produce lithium hydroxide monohydrate (LiOH·H₂O) of battery-quality.

Described herein are systems, processes (also referred to as methods), and techniques for preparing purified lithium salts such as lithium carbonate and/or lithium hydroxide from a lithium-containing solution. For example, the systems and techniques of the present disclosure can prepare, from a lithium-containing solution (e.g., geothermal brines), purified lithium carbonate and/or lithium hydroxide using an ion exchange resin.

In some examples, the present disclosure can add an aqueous composition comprising lithium ions (e.g., a lithium-based solution such as lithium chloride solution) into a column, which contains ion exchange resins saturated with sodium. As follows, lithium ions displace sodium in the column and therefore, sodium salts (e.g., sodium chloride) exit the column and the column is loaded with lithium. In some aspects, the lithium-loaded column can be washed with water to remove any residual sodium salts from the column.

In some cases, a concentrated sodium hydroxide solution can be introduced to the lithium-loaded column. Due to a high concentration of the sodium hydroxide solution, sodium ions start to displace lithium from the column. As such, the resulting output of the column includes a lithium hydroxide solution.

In some approaches, the resulting lithium hydroxide solution can be evaporated and crystallized to form high-purity lithium hydroxide monohydrate crystals.

In some aspects, the lithium hydroxide solution can be reacted with pure carbon dioxide to produce high-purity lithium carbonate. In some cases, the carbon dioxide can be supplied from CO₂ emissions from gas-fired equipment.

Aspects of the present disclosure can improve the extraction of lithium from lithium-containing brines/minerals and the preparation of lithium salts such as lithium carbonate and lithium hydroxide of sufficient purity to produce high-purity and battery-grade lithium metal. Since mineral reagents such as soda ash (sodium carbonate) and lime that contain impurities are not consumed in the present disclosure, the systems and technologies of the present disclosure can significantly avoid product contamination. Further, since membrane or electronic grade sodium hydroxide and pure CO₂ are readily available. As such, the present disclosure can improve the efficiency and productivity of preparing lithium carbonate and lithium hydroxide.

Further, the systems and technologies of the present disclosure can be modularized and incorporated in a mobile extraction train such as a modular system (e.g., a modular extraction system) for extracting desired chemical species including lithium, specific lithium species, and/or other chemical compounds from input flows in a modular unit. In particular, the present disclosure has exemplary applicability in the Modular Extraction Apparatus described in U.S. Pat. No. 11,229,880.

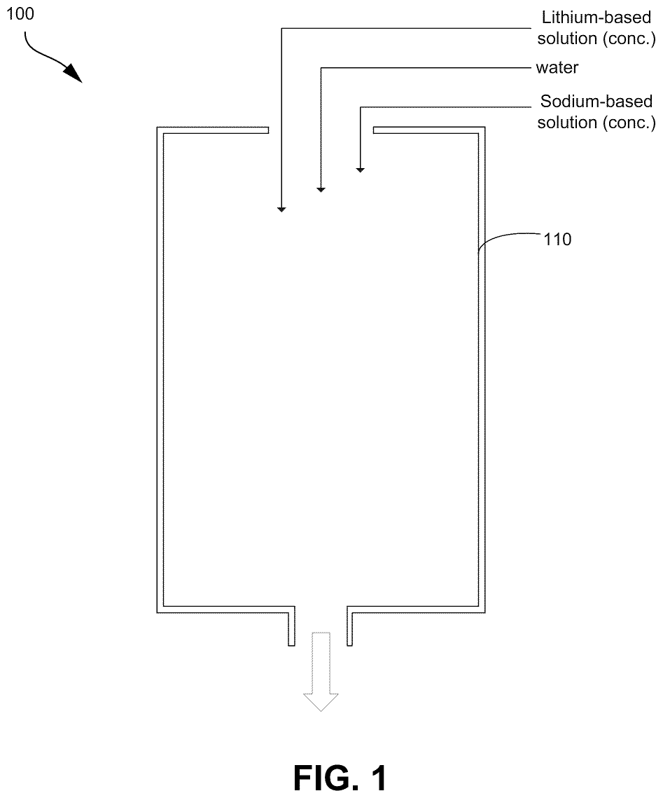

FIG. 1 illustrates an example system 100 for preparing lithium carbonate and lithium hydroxide. As illustrated, system 100 includes a column 110 (also referred to as a resin column, an ion exchange resin bed, etc.). In various examples, the column 110 can be a pulsed column, separation column, or any applicable column that liquid can flow through.

In some examples, column 110 can be prepared with a strong acid ion exchange resin (e.g., Dowex 50), which is saturated with sodium. First, a lithium-based solution (concentrated) (e.g., lithium chloride) can be introduced into column 110. As the lithium-based solution is pumped into column 110 and flows through column 110, lithium ions displace sodium. As follows, sodium salts (e.g., sodium chloride) exit column 110, and column 110 becomes loaded with lithium.

In some aspects, the lithium-loaded column 110 can be washed with clean water to remove any residual sodium salts (e.g., sodium chloride).

In some cases, a sodium hydroxide solution (concentrated) can be introduced into the lithium-loaded column 110. A high concentration of the sodium hydroxide solution leads to sodium ions displacing lithium from column 110. As follows, lithium hydroxide solution of high purity can be produced as an output of column 110.

The resulting lithium hydroxide solution can be evaporated and crystallized to form lithium hydroxide monohydrate crystals (LiOH·H₂O). Further, the lithium hydroxide solution can be reacted with carbon dioxide to produce lithium carbonate (Li₂Co₃).

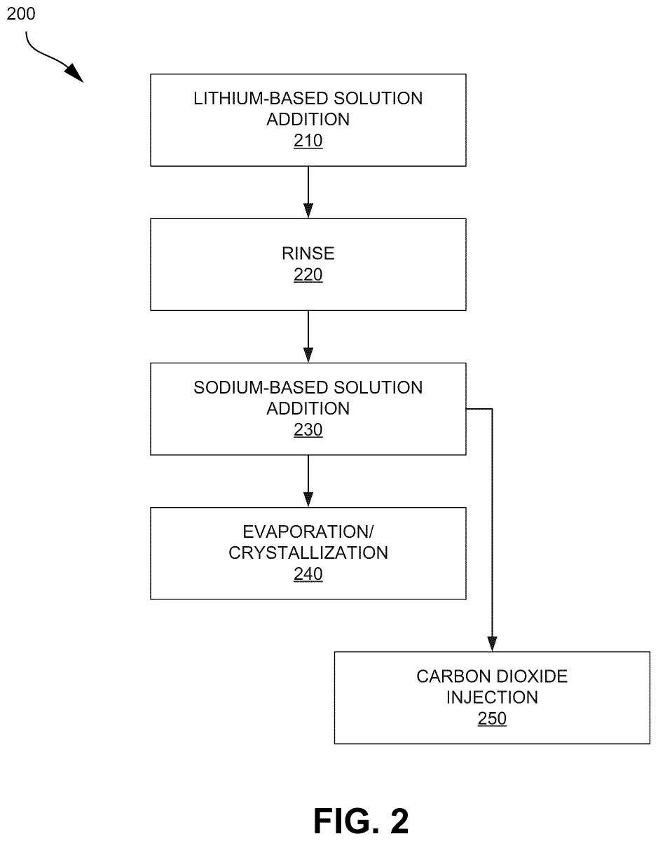

Further details relating to the process of preparing lithium carbonate and lithium hydroxide based on the example system 100 are provided below with respect to FIG. 2.

As previously described, in some aspects, system 100 can be incorporated into a modular system (e.g., a modular extraction system) for extracting desired chemical species including lithium, specific lithium species, and/or other chemical compounds from input flows in a modular unit. For example, column 100 can be included as part of a column array within a modular and mobile extraction system. In some cases, input to column 100 (e.g., lithium-based solution, water, sodium-based solution, etc. as described herein) can be contained in one or more tanks provided within the modular and mobile extraction system.

FIG. 2 illustrates an example process 200 for preparing lithium carbonate and lithium hydroxide according to some examples of the present disclosure. Although the example process 200 depicts a particular sequence of operations, the sequence may be altered without departing from the scope of the present disclosure. For example, some of the operations depicted may be performed in parallel or in a different sequence that does not materially affect the function of process 200. In other examples, different components of an example device or system that implements process 200 may perform functions at substantially the same time or in a specific sequence.

At step 210, process 200 includes adding lithium-based solution to a column (e.g., column 110 as illustrated in FIG. 1). For example, an aqueous composition comprising lithium ions (e.g., a lithium-based solution such as lithium chloride solution) can be introduced into a column that comprises ion exchange resins. The ion exchange resins can be in the form of organic polymer beads, membranes, or other structures. In some examples, the ion exchange resins may include cation exchange resins that have functional groups that are strong acid groups. That is, the ion exchange resins can include strong acidic cation exchanger (e.g., Dowex 50). As previously described, column 110 can include ion exchange resins, which may be saturated with sodium. Non-limiting examples of ion exchange resins include sulphonic acid, sulfonate groups, or a combination thereof. In some examples, the ion exchange resins can be washed with water prior to the addition of lithium-based solution into column 110.

In some aspects, a lithium-based solution can be prepared by processing a lithium chloride-containing solution. For example, brine solution can be processed to prepare a lithium-based solution. Brines can be aqueous solutions that may include alkali metal or alkaline earth chlorides, bromides, sulfates, hydroxides, nitrates, and the like, as well as natural brines. Brines can be obtained from natural sources, such as, Chilean brines or Salton Sea geothermal resource brines, geothermal brines, sea water, mineral brines (e.g., lithium chloride or potassium chloride brines), alkali metal salt brines, and industrial brines, for example, industrial brines recovered from ore leaching, mineral dressing, and so on.

Even though the selectivity coefficient for sodium is higher than the selectivity coefficient of lithium, the lithium ions that are being pumped into the column 110 will displace sodium from the resin due to mass action. In other words, a high concentration of lithium-based solution (e.g., lithium chloride), which is introduced at the top of column 110 will displace the relatively small amount of sodium at the top of column 110 because the Li to Na ratio is very high (e.g., a fraction of Li to Na ratio is over 1).

As more lithium-based solution (e.g., lithium chloride) is pumped into column 110, sodium will continue to be displaced, ultimately exiting column 110 as sodium salts (e.g., sodium chloride solution).

At step 220, process 200 includes rinsing/washing the column with water. For example, column 110, which is loaded with lithium from step 210, may be washed with clean water to remove any residual sodium salts such as sodium chloride.

At step 230, process 200 includes adding sodium-based solution. For example, a concentrated solution of high-purity sodium hydroxide (NaOH) can be injected into column 110.

In some examples, sodium ions from a sodium-based solution outnumber lithium ions in the column. For example, a number of sodium ions significantly exceeds a number of lithium ions. As follows, sodium ions displace lithium ions from column 110, and therefore, lithium hydroxide is produced as a resulting output.

At step 240, process 200 includes evaporation and/or crystallization. For example, the lithium hydroxide solution produced from step 230 can be evaporated and crystallized to form high-purity lithium hydroxide monohydrate crystals (LiOH·H₂O). In some cases, the crystals cane washed, dried, and packaged for battery manufacturers.

At step 250, process 200 includes adding carbon dioxide (CO₂). For example, carbon dioxide can be injected into column 110. As follows, lithium hydroxide solution can be reacted with carbon dioxide to produce lithium carbonate (Li₂Co₃) without the use of soda ash or lime. In some examples, carbon dioxide can be supplied from carbon dioxide emissions from gas-fired equipment such as a natural gas generator (e.g., boilers).

In some aspects, the purity of lithium carbonate can be: 99.99%. For example, the pure lithium carbonate produced in step 250 can contain lithium in excess of 99.999% purity.

In some examples, a lithium-based solution can be added to concentrated sodium hydroxide, which causes precipitation of sodium salts. Non-limiting examples of lithium-based solutions include lithium chloride, lithium sulfate, lithium acetate, lithium bromide, and so on. The resulting sodium-lithium-chloride-hydroxide solution can be crystallized, precipitating sodium salts (e.g., sodium chloride). Further evaporation may lead to lithium hydroxide monohydrate (LiOH·H₂O), which can be washed and dried, producing a high-purity product.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: adding an aqueous composition comprising lithium ions into a column, wherein the column comprises ion exchange resins saturated with sodium; adding water into the column to remove residual sodium salts; an adding a sodium hydroxide solution to the column to obtain lithium hydroxide.

Aspect 2. The method of Aspect 1, further comprising: evaporating the lithium hydroxide to produce lithium hydroxide monohydrate crystals.

Aspect 3. The method of Aspects 1 or 2, further comprising: reacting the lithium hydroxide with carbon dioxide to obtain lithium carbonate.

Aspect 4. The method of any of Aspects 1 to 3, wherein the ion exchange resin comprises an acidic cation exchanger.

Aspect 5. The method of any of Aspects 1 to 4, wherein the ion exchange rein comprises at least one of sulphonic acid, sulfonate groups, or a combination thereof.

Aspect 6. The method of any of Aspects 1 to 5, wherein the aqueous composition comprising lithium ions comprises a lithium chloride solution.

Aspect 7. The method of any of Aspects 1 to 6, wherein a number of sodium ions in the sodium hydroxide solution exceeds a number of lithium ions in the column when adding the sodium hydroxide solution to the column.

Aspect 8. The method of any of Aspects 1 to 7, further comprising: adding lithium chloride to the sodium hydroxide solution to obtain sodium lithium chloride hydroxide solution; and evaporating the sodium lithium chloride hydroxide solution to obtain lithium hydroxide monohydrate.

Aspect 9. The method of any of Aspects 1 to 8, further comprising: deploying the column into a modular extraction system of extracting lithium from brines.

Aspect 10. The method of any of Aspects 1 to 9, wherein the lithium carbonate obtained from the column contains lithium in excess of 99.999% purity.

What is claimed is:

1. A method comprising:
adding an aqueous composition comprising lithium ions into a column, wherein the column comprises ion exchange resins saturated with sodium;
adding water into the column to remove residual sodium salts; and
adding a sodium hydroxide solution to the column to obtain lithium hydroxide.

2. The method of claim 1, further comprising:
evaporating the lithium hydroxide to produce lithium hydroxide monohydrate crystals.

3. The method of claim 1, further comprising:
reacting the lithium hydroxide with carbon dioxide to obtain lithium carbonate.

4. The method of claim 1, wherein the ion exchange resin comprises an acidic cation exchanger.

5. The method of claim 1, wherein the ion exchange rein comprises at least one of sulphonic acid, sulfonate groups, or a combination thereof.

6. The method of claim 1, wherein the aqueous composition comprising lithium ions comprises a lithium chloride solution.

7. The method of claim 1, wherein a number of sodium ions in the sodium hydroxide solution exceeds a number of lithium ions in the column when adding the sodium hydroxide solution to the column.

8. The method of claim 1, further comprising:
adding lithium chloride to the sodium hydroxide solution to obtain sodium lithium chloride hydroxide solution; and
evaporating the sodium lithium chloride hydroxide solution to obtain lithium hydroxide monohydrate.

9. The method of claim 1, further comprising:
deploying the column into a modular extraction system of extracting lithium from brines.

10. The method of claim 3, wherein the lithium carbonate obtained from the column contains lithium in excess of 99.999% purity.
